(19) United States
(12) Patent Application Publication
(10) Pub. No.: US 2006/0074147 A1
(43) Pub. Date: Apr. 6, 2006

(54) Cast material having color effect

(76) Inventor: Michael A. Mayo, Pittsburgh, PA (US)

Correspondence Address: PPG INDUSTRIES, INC.;Intellectual Property Department, One PPG Place, Pittsburgh, PA, 15272, US

(21) Appl. No.: 10/959,745

(22) Filed: Oct. 6, 2004

(51) Int. Cl. C09D 5/29

(52) U.S. Cl. 523/171

(57) ABSTRACT

Cast materials having a color effect composition are disclosed. The materials are transparent and/or translucent.

### FIELD OF THE INVENTION

The present invention is related to cast material having a color effect composition.

### BACKGROUND OF THE INVENTION

Transparent and translucent materials having color and/or various color effects are desired in a number of industries including sports equipment and apparel, decorative articles, advertising displays, consumer products, and the like. Transparent and translucent cast materials are colored with dyes, which are typically not very durable. Accordingly, methods for achieving more stable color and/or various color and/or visual effects are desired.

### SUMMARY OF THE INVENTION

The present invention is directed to translucent and/or transparent cast material having at least one color effect composition that imparts a desired color and/or visual effect that is not generated solely through the use of a dye.

### BRIEF DESCRIPTION OF THE FIGURES

FIG. 1 is a cross-section of a color effect composition made in accordance with one embodiment of the present invention.

### DETAILED DESCRIPTION OF THE INVENTION

The present invention is directed to cast materials having at least one color effect composition. As used herein, “castable material” and like terms refer to material that is dispensed as a liquid into an open or closed mold cavity and then cured to form a solid object; the solid object is a “cast material”. Examples of castable materials include polyurethanes, polyureas, epoxies and/or silicones.

The cast material of the present invention is translucent and/or transparent. As used herein, “translucent” and like terms refer to materials that allow light to pass through, but that cause sufficient diffusion to eliminate perception of distinct images. “Transparent” and like terms refer to materials that are capable of transmitting light so that objects or images can be substantially seen as if there were no intervening material. In some nonlimiting embodiments, the cast material having at least one color effect composition may be transparent in part and translucent in part. It will also be appreciated that more than one castable material may be used. For example, the scope of the present invention includes casting a castable material, partially allowing it to ‘set’, and then casting another material directly onto the first; the first and second materials can be the same or different.

In certain nonlimiting embodiments, the cast material comprises a polyurethane, a copolymer of a polyurethane, a polyurea, and/or copolymer of a polyurea. The polyurethane, the copolymer of the polyurethane, the polyurea, and/or the copolymer of the polyurea can be prepared from an isocyanate and a compound having at least two active hydrogens, such as a polyol, polyamine, polymercaptan, polyacid, and the like. The isocyanate can either be aromatic or aliphatic, or a combination thereof. Aliphatic isocyanates typically provide better color stability under light exposure than aromatic isocyanates and therefore may be more suitable for particular applications.

Any isocyanate available to one of ordinary skill in the art is suitable for use according to this invention. The isocyanate may be, for example, organic, modified organic, saturated, aliphatic, alicyclic, unsaturated, araliphatic, aromatic, substituted, or unsubstituted polyisocyanate monomers having two or more free reactive isocyanate (“NCO”) groups, isomers thereof, modified derivatives thereof, dimers thereof, trimers thereof, or isocyanurates thereof.

The isocyanate may also include any isocyanate-containing multimeric adducts, oligomers, polymers, prepolymers, low-free-isocyanate monomer prepolymers, quasi-prepolymers, and modified polyisocyanates derived from the above-isocyanates and polyisocyanates.

In certain nonlimiting embodiments, the isocyanates include diisocyanates (having two NCO groups per molecule), dimerized uretidones thereof, trimerized isocyanurates thereof, and isocyanates having three or more NCO groups per molecule, such as monomeric triisocyanates. Any and all of the isocyanates disclosed herein may be used alone or in combination of two or more thereof.

Diisocyanates typically have the generic structure of O═C═N—R—N═C═O, where R is a cyclic, aromatic, aliphatic, linear, branched, or substituted hydrocarbon moiety containing from 1 to about 20 carbon atoms, such as arylenes, aralkylenes, alkylenes, or cycloalkylenes. When multiple cyclic or aromatic groups are present, linear, branched or substituted hydrocarbons containing from 1 to about 10 carbon atoms can be present as spacers between such cyclic or aromatic groups. In some cases, the cyclic or aromatic group(s) may be substituted at the 2-(ortho-), 3-(meta-), and/or 4-(para-) positions. Substituted groups may include, but are not limited to, halogens, cyano groups, amine groups, silyl groups, hydroxyl groups, acid groups, alkoxy groups, primary or secondary or tertiary hydrocarbon groups, or a combination of two or more groups thereof.

Suitable examples of unsaturated diisocyanates include, but are not limited to:
(1) para-phenylene diisocyanate (“PPDI,” ie., 1,4-phenylene diisocyanate), meta-phenylene diisocyanate (“MPDI,” i.e., 1,3-phenylene diisocyanate), ortho-phenylene diisocyanate (i.e., 1,2-phenylene diisocyanate), 4-chloro-1,3-phenylene diisocyanate;
(2) toluene diisocyanate (“TDI”), meta-tetramethylxylene diisocyanate (“m-TMXDI”), para-tetramethylxylene diisocyanate (“p-TMXDI”), ortho-, meta-, and para-xylene diisocyanates,
(3) 2,2′-, 2,4′-, and 4,4′-biphenylene diisocyanates, 3,3′-dimethyl-4,4′-biphenylene diisocyanate (“TODI”);
(4) 2,2′-, 2,4′-, and 4,4′-diphenylmethane diisocyanates (“MDI”), 3,3′-dimethyl-4,4′- diphenylmethane diisocyanate, carbodiimide-modified MDI, polymeric MDI (PMDI, a brown liquid composed of approximately 50% methylene diisocyanate with the remainder comprised of oligomers of MDI);
(5) 1,5-naphthalene diisocyanate (NDI), 1,5-tetrahydronaphthalene diisocyanate, anthracene diisocyanate, tetracene diisocyanate;
(6) 2,3,5,6-tetramethyl-1,4-diisocyanatobenzene (durene diisocyanate);
(7) o-xylylene diisocyanate (XDI), m-xylylene diisocyanate (XDI), p-xylylene diisocyanate (XDI); and the like.

Suitable examples of saturated diisocyanates include, but are not limited to:
(1) 1,4-tetramethylene diisocyanate, 1,5-pentamethylene diisocyanate, 2-methyl-1,5-pentamethylene diisocyanate, 1,6-hexamethylene diisocyanate (“HDI”) and isomers thereof, 2,2,4- and 2,4,4-trimethylhexamethylene diisocyanates, 1,7-heptamethylene diisocyanate and isomers thereof, 1,8-octamethylene diisocyanate and isomers thereof, 1,9-novamethylene diisocyanate and isomers thereof, 1,10-decamethylene diisocyanate and isomers thereof, 1,12-dodecane diisocyanate and isomer thereof;
(2) 1,3-cyclobutane diisocyanate, 1,2-, 1,3-, and 1,4-cyclohexane diisocyanates, 2,4- and 2,6-methylcyclohexane diisocyanates (“HTDI”);
(3) isophorone diisocyanate (“IPDI”), isocyanatomethylcyclohexane isocyanate, isocyanatoethylcyclohexane isocyanate, 1,2-, 1,3-, and 1,4-bis-(isocyanatomethyl)cyclohexane, 1-isocyanatocyclohexane;
(4) 1,3-bis-(1-isocyanato-1-methylethyl)-cyclohexane (hydrogenated version of m-TMXDI);
(5) 4,4′-dicyclohexylmethane diisocyanate (“H₁₂MDI,” a.k.a. bis(4-isocyanatocyclohexyl)-methane), 2,4′- and 4,4′-dicyclohexane diisocyanates, 2,4′-and 4,4′-bis(isocyanatomethyl) dicyclohexanes, and the like.

Dimerized uretidones of polyisocyanates include, for example, unsaturated isocyanates such as uretidones of toluene diisocyanates, uretidones of diphenylmethane diisocyanates, and saturated isocyanates such as uretidones of hexamethylene diisocyanates.

Trimerized isocyanurates of polyisocyanates include, for example, isocyanurates of toluene diisocyanates, and saturated isocyanates such as isocyanurates of isophorone diisocyanate, isocyanurates of hexamethylene diisocyanate, HDI biuret prepared from HDI, and isocyanurates of trimethylhexamethylene diisocyanates.

Monomeric triisocyanates include, for example, unsaturated isocyanates such as 2,4,4′-diphenylene triisocyanate, 2,4,4′-diphenylmethane triisocyanate, 4,4′,4″-triphenylmethane triisocyanate, and saturated isocyanates such as 1,3,5-cyclohexane triisocyanate, 3-aminomethyl-1,6-hexamethylene, 3-cyanate methyl-1,6-hexamethylene diisocyanate, and triisocyanatononane.

Other isocyanates include unsaturated isocyanates, such as those that are araliphatic, including 1,2-, 1,3-, and 1,4-xylene diisocyanates, meta-tetramethylxylene diisocyanate, para-tetramethylxylene diisocyanate, uretidones of toluene diisocyanates, isocyanurates of toluene diisocyanates, and isocyanurates of diphenylmethane diisocyanates.

Isocyanate-containing oligomers and polymers include any oligomers and polymers having two or more free reactive isocyanate groups as terminal groups and/or pendent groups on the oligomeric or polymeric backbones. Isocyanate-terminated prepolymers and quasi-prepolymers are well known to the skilled artisan, and include, but are not limited to, the reaction products of any one or more of the isocyanates and any one or more of the hydroxyl-terminated and/or amine-terminated compounds disclosed herein.

The isocyanate suitable for the present invention may have any percent isocyanate (NCO). The term “percent NCO” refers to the percent by weight of free, reactive, and unreacted isocyanate functional groups in an isocyanate-functional molecule or material. The total atomic weight of all the NCO groups in the molecule or material, divided by its total molecular weight, and multiplied by 100, equals the percent NCO. In certain nonlimiting embodiments, the isocyanate comprises an isocyanate-terminated prepolymer having no greater than about 14 percent NCO, such as no greater than about 10 percent NCO, or no greater than about 7 percent. It is well understood in the art that material hardness of polyureas, polyurethanes, and polyurethane/polyurea hybrids can readily be modified by adjusting the percent NCO content in the isocyanate-terminated prepolymer.

As noted above, the polyurethane, the copolymer of the polyurethane, the polyurea, and/or the copolymer of the polyurea may be prepared from a compound having at least two active hydrogens. Illustrative of active hydrogen-containing moieties are —COOH, —OH, NH₂, —NH, —CONH₂, —SH and —CONH—. Such moieties, it will be understood, are found on polyols, polyamines, polyamides, polymercaptans, polyacids, and the like.

The active hydrogen-containing compound suitable for use in the present invention may be organic, modified organic, saturated, aliphatic, alicyclic, unsaturated, araliphatic, aromatic, substituted, or unsubstituted. The two or more reactive hydrogen groups per molecule can be, for example, primary or secondary hydroxyl groups or amine groups; the active hydrogen-containing compound can comprise at least one cyclic, aromatic, aliphatic, linear, branched, or substituted hydrocarbon moiety containing from 1 to about 20 carbon atoms, such as arylenes, aralkylenes, alkylenes, or cycloalkylenes. When multiple cyclic or aromatic groups are present, linear, branched or substituted hydrocarbons containing from 1 to about 10 carbon atoms can be present as spacers between such cyclic or aromatic groups. In some cases, the cyclic or aromatic group(s) may be substituted at the 2-(ortho-), 3-(meta-), and/or 4-(para-) positions. Substituted groups may include, but are not limited to, halogens, cyano groups, amine groups, silyl groups, hydroxyl groups, acid groups, alkoxy groups, primary or secondary or tertiary hydrocarbon groups, or a combination of two or more groups thereof. Any and all of the active hydrogen-containing compounds disclosed herein may be used alone or in combination of two or more thereof.

The active hydrogen-containing compounds may be hydroxy-and/or amine-terminated oligomers or polymers, such as those suitable for use in forming a prepolymer with the isocyanate, or hydroxy- and/or amine-containing compounds reactive with the prepolymer or the isocyanate, such as those used as curing agents for chain-extension and/or crosslinking. The hydroxy-and/or amine groups may be terminal or pendant groups on the oligomeric or polymeric backbone, and in the case of secondary amine groups, may even be embedded within the backbone.

In certain nonlimiting embodiments, the hydroxy-terminated oligomers or polymers have a molecular weight of at least about 200 and at least two primary or secondary hydroxyl terminal groups per molecule, and include, but are not limited to (a) hydroxy-terminated polyethers, (b) hydroxy-terminated polyesters, (c) hydroxy-terminated polycaprolactones, (d) hydroxy-terminated polycarbonates, (e) hydroxy-terminated polyhydrocarbons, (f) hydroxy-terminated oligomers or polymers, and any combination thereof.

Suitable examples of hydroxy-terminated polyethers include, but are not limited to, polytetramethylene ether glycol (“PTMEG”), low-molecular-weight PTMEG, modified PTMEG, hydroxyl-terminated copolymer of polytetrahydrofuran and polymethyltetrahydrofuran (“PTG-L”), poly(oxyethylene)glycol, poly(oxypropylene)glycol, (ethylene oxide)-capped poly(oxypropylene) ether glycol, poly(oxyethylene-co-oxypropyiene) glycol, 2-ethyl-2-(hydroxymethyl)-1,3-propanediol, and the like.

Suitable examples of hydroxy-terminated polyesters include, but are not limited to, poly(ethylene adipate) glycol, poly(propylene adipate) glycol, poly(butylene adipate) glycol, poly(hexamethylene adipate) glycol, poly(ethylene propylene adipate) glycol, poly(ethylene butylene adipate) glycol, poly(hexamethylene butylene adipate) glycol, propylene glycol-based alkylhexahydrophthalic polyester polyols, propylene glycol-based alkyltetrahydrophthalic polyester polyols, dipentaerythritol-based alkylhexahydrophthalic polyester polyols, dipentaerythritol-based alkyltetrahydrophthalic polyester polyols, (o-phthalate-1,6-hexanediol)-based polyester polyol, poly(ethylene terephthalate)-based polyester polyol, and the like.

Suitable examples of hydroxy-terminated polycaprolactones include, but are not limited to (alkylene oxide)-initiated polycaprolactones, (ethylene glycol)-initiated polycaprolactone, (diethylene glycol)-initiated polycaprolactone, (propylene glycol)-initiated polycaprolactone, (dipropylene glycol)-initiated polycaprolactone, 1,4-butanediol-initiated polycaprolactone, trinethylolpropane-initiated polycaprolactone, (neopentyl glycol)-initiated polycaprolactone, 1,6-hexanediol-initiated polycaprolactone, PTMEG-initiated polycaprolactone, 2-ethyl-2-(hydroxymethyl)-1,3-propanediol initiated polycaprolactone, and the like.

Suitable examples of hydroxy-terminated polycarbonates include, but are not limited to, poly(phthalate carbonate) glycol, poly(hexamethylene carbonate) glycol, poly(1,4-cyclohexanedimethylene carbonate) glycol, (bisphenol A)-based polycarbonate glycols, and the like.

Suitable examples of hydroxy-terminated polyhydrocarbons include, but are not limited to, polyisoprene polyol (i.e., liquid isoprene rubber), poly(hydrogenated isoprene) polyol, polybutadiene polyol, poly(hydrogenated butadiene) polyol, and the like.

Suitable examples of hydroxy-terminated acid functional oligomers or polymers (or ionomers thereof derived from partial or full neutralization with organic or inorganic cations), include, but are not limited to, dimerate or trimerate polyols of fatty acids or isostearic acid, acid functional polyols as disclosed, for example, in U.S. Pat. No. 6,207,784.

Other hydroxy-terminated polymers, such as hydroxy-terminated polyolefins, hydroxy-terminated polyamides, glycerol-based polyols, (castor oil)-based polyols, hydroxy-terminated alkylene-styrene copolymers (i.e., KRATON polyols), and hydroxy-terminated acrylic polyols, can also be used.

Saturated members of the above-listed hydroxy-terminated oligomers or polymers are used in certain nonlimiting embodiments of the present invention, because they have been observed as having superior light stability in certain applications. Saturated hydroxy-terminated polymers may be aliphatic, alicyclic, or fully hydrogenated. Suitable examples of saturated hydroxy-terminated polymers include, but are not limited to, PTMEG, low-molecular-weight PTMEG, modified PTMEG, PTG-L, poly(oxyethylene)glycol, poly(oxypropylene)glycol, (ethylene oxide)-capped poly(oxypropylene) ether glycol, poly(ethylene adipate) glycol, poly(butylene adipate) glycol, poly(hexamethylene adipate) glycol, poly(ethylene propylene adipate) glycol, poly(ethylene butylene adipate) glycol, poly(hexamethylene butylene adipate) glycol, (alkylene oxide)-initiated polycaprolactones, (ethylene glycol)-initiated polycaprolactone, (diethylene glycol)-initiated polycaprolactone, (propylene glycol)-initiated polycaprolactone, (dipropylene glycol)-initiated polycaprolactone, 1,4-butanediol-initiated polycaprolactone, trimethylolpropane-initiated polyca prolactone, (neopentyl glycol)-initiated polycaprolactone, 1,6-hexanediol-initiated polycaprolactone, PTMEG-initiated polycaprolactone, poly(hexamethylene carbonate) glycol, saturated poly(hydrogenated isoprene) polyol, saturated poly(hydrogenated butadiene) polyol, saturated dimerate or trimerate polyols of fatty acids or isostearic acid, saturated hydroxy-terminated polyolefins, saturated hydroxy-terminated polyamides, saturated glycerol-based polyols, saturated (castor oil)-based polyols, and saturated hydroxy-terminated alkylene-styrene copolymers.

In certain nonlimiting embodiments, amine-terminated oligomers or polymers used according to the present invention have a molecular weight of at least about 200 and at least two primary or secondary amine terminal groups per molecule. Because lower molecular weight amine-terminated polymers may be prone to forming solids, a high molecular weight between about 1,000 and about 5,000 may be particularly suitable in certain applications. Suitable examples of amine-terminated oligomers or polymers include, but are not limited to, (a) amine-terminated polyethers, (b) amine-terminated polymers, (c) amine-terminated polycaprolactones, (d) amine-terminated polycarbonates, (e) amine-terminated polyhydrocarbons, (f) amine-terminated acid functional polymers, (g) amine-terminated polyolefins, (h) amine-terminated polyamides, (i) amine-terminated polyacrylics, and any combination thereof. Such compounds can be prepared using methods known in the art.

Suitable examples of amine-terminated polyethers include, but are not limited to, polyoxyalkylene diamines, polyoxyethylene diamines, polyoxypropylene diamines, polyoxypropylene triamine, poly(tetramethylene ether) diamines, (ethylene oxide)-capped polyoxypropylene ether diamines, poly(triethyleneglycol) diamines, poly(trimethylolpropane) triamines, polyethyleneglycol-di(p-aminobenzoate), polytetramethyleneoxide-di(p-aminobenzoate), glycerin-based triamines, and the like.

Saturated members of the above-listed amine-terminated polymers may be more suitable in certain nonlimiting embodiments of the present invention, because they have been observed as having superior light stability when used in certain applications. Saturated amine-terminated polymers may be aliphatic, alicyclic, or fully hydrogenated. Suitable examples of saturated amine-terminated polymers include, but are not limited to, polyoxyalkylene diamines and/or triamines, poly(tetramethylene ether) diamines, (ethylene oxide)-capped polyoxypropylene ether diamines, poly(triethyleneglycol) diamines, poly(trimethylolpropane) triamines, saturated glycerin-based triamines, saturated amine-terminated polyesters, saturated amine-terminated polycaprolactones, saturated amine-terminated polycarbonates, saturated amine-terminated polyhydrocarbons, saturated amine-terminated acid functional polymers, saturated amine-terminated polyolefins, saturated amine-terminated polyamides, and saturated amine-terminated polyacrylics.

As noted above, the present cast materials have at least one color effect composition. “Color effect composition” and like terms refer to any composition that imparts a desired color and/or visual effect to the composition while maintaining the transparency and/or translucency of the cast material and wherein the color and/or visual effect is not generated solely through use of a dye. In general, the color effect composition can be used in an amount sufficient to impart the desired visual and/or color effect. In certain embodiments, the effect is to produce a color shift; that is, the color of the cast material changes when the material is viewed at different angles. In certain embodiments, the amount of color effect composition is used in a pigment to binder ratio of 0.1:1 or even 0.01:1, wherein the “binder” refers to the castable material. Certain nonlimiting embodiments exclude the use of carbazole dioxazine crude pigment, SiO₂ flakes coated with one or more metal oxides and/or metals in conjunction with platelet-shaped, circular or spherical colorants or fillers, and multilayer pigments based on mica, SiO₂ flakes, glass flakes, alumina flakes or polymer flakes in conjunction with platelet-shaped, circular or spherical colorants or fillers.

Examples of color effect compositions within the present invention include compositions that comprise transparent coated micas and/or synthetic micas, coated silica, coated alumina, transparent liquid crystal pigments, liquid crystal coatings, and/or any composition wherein interference results from a refractive index differential within the material and not because of the refractive index differential between the surface of the material and the air. In certain nonlimiting embodiments, the color effect composition comprises an ordered periodic array of particles held in a matrix. In other nonlimiting embodiments, the particles in the array comprise a radiation diffractive material.

In certain nonlimiting embodiments of the present invention, the color effect composition includes an ordered periodic array of particles held in a matrix wherein the difference in refractive index between the matrix and the particles is at least about 0.01, such as at least about 0.05, or at least about 0.1. The matrix may be an organic polymer, such as a polyurethane, polycarbonate, polystyrene, acrylic, alkyd, polyester, siloxane, polysulfide, epoxy or mixtures thereof and, in one embodiment, is crosslinked. Alternatively, the matrix may be an inorganic polymer, such as a metal oxide (e.g. alumina, silica or titanium dioxide) or a semiconductor (e.g. cadmium selenide).

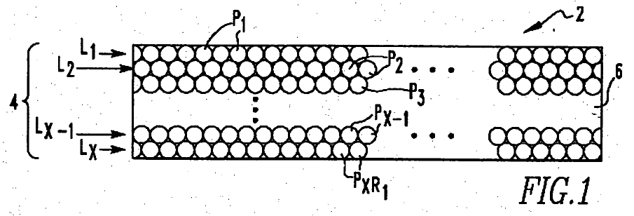

As shown in FIG. 1, the color effect composition 2 used according to certain embodiments of the present invention includes an array 4 of particles P₁, P₂, . . . Pₓ₋₁, and Pₓ held in a polymeric matrix 6. The volumetric ratio of particles to matrix can range from 25:75 to 80:20, such as 72:28 to 76:24. The particles typically have an average particle size of about 0.01 to about 1 micron, such as 0.06 to 0.5 micron; the particles will typically be similar in size and in certain embodiments differ in size from each other by a maximum of 5 to 15 percent. The particles are arranged in layers L₁, L₂, . . . Lₓ₋₁, and Lₓ stacked upon each other so that the surfaces of the particles P₁-Pₓ contact each other. The surface of each particle contacts at least one other particle. The particles P₁-Pₓ may be composed of an organic polymer, such as a polyurethane, polycarbonate, polystyrene, an acrylic polymer, an alkyd polymer, polyester, siloxane polymer, polysulfide, an epoxy-containing polymer or a polymer derived from an epoxy-containing polymer. In certain embodiments, the polymer is crosslinked. Alternatively, the particles P₁-Pₓ may be composed of an inorganic polymer or material, such as a metal oxide (e.g. alumina, silica or titanium dioxide) or a semiconductor (e.g. cadmium selenide). In one embodiment, the particles and the matrix can comprise the same material, provided there is a refractive index differential.

In certain nonlimiting embodiments, the particles are fixed in the matrix by providing a dispersion of the particles, all bearing a similar charge, in a carrier, applying the dispersion onto a substrate such as a temporary substrate, evaporating the carrier to produce an ordered periodic array of the particles on the substrate, coating the array of particles with the matrix, and curing the matrix to fix the array of particles within the polymer. The dispersion may contain about 1 to about 70 vol. % of the charged particles, such as about 30 to about 65 vol. % of the charged particles. The substrate may be a flexible material (such as a polyester film) or an inflexible material (such as glass). The dispersion can be applied to the substrate by dipping, spraying, brushing, roll coating, curtain coating, flow coating or die coating to a desired thickness, such as a thickness of about 20 microns, about 10 microns, or about 5 microns. The fixed array of particles can be removed from the substrate in the form of an extended film or continuous layer, or removed from the substrate and converted into particles or flakes. When in the form of an extended film or continuous layer, the layer itself can be applied to the castable material. The thickness of the film or layer can vary depending on the needs of the user. For example, the film or layer can be about 100 microns or less, such as 20 microns or less or 10 microns or less. When in particulate or flake form, the particles or flakes can be added to a coating and applied to the castable material. In these embodiments, the particles/flakes can comprise 0.1 to 40 weight percent, such as 1 to 20 or 5 to 15 weight percent of the color effect composition, i.e. the coating comprising the particles/flakes. Any coating can be used, and should be selected so as not to interfere with the desired transparency and/or translucency of the cast material. In other embodiments, the particles with flakes can be added to the castable material itself. In these embodiments, the particles/flakes can comprise 0.1 to 40 weight percent, such as 1 to 20 or 5 to 15 weight percent, of the total weight of the castable material. The size of the particles/flakes can range from 5 to 5000 microns in diameter, such as 5 to 100 or 10 to 50. The color effect composition of these embodiments are further described in U.S. Patent Application Publication No. 2003/0125416, incorporated by reference herein.

In certain embodiments of the present invention, the color effect composition includes one or more highly dispersed nanosized colorants or colorant particles that produce a desired visible color. The terms colorant(s) and colorant particle(s) are used interchangeably herein. The higher the level of dispersion of the colorant(s), the lower the haze. In certain embodiments, a majority (i.e. greater than 50% based on either the number of colorant particles or on the weight of the colorant particles) of the colorant used has a maximum haze and/or a narrow absorbance peak in the visible spectrum. As used herein, the “visible spectrum” includes wavelengths of about 400 nm to about 700 nm. In certain embodiments, the color effect composition of the present invention includes colorant particles, and a resinous binder.

The colorant particle(s) used in certain embodiments of the present invention can be, for example, pigments, and can have a primary particle size of less than about 150 nm, such as less than about 70 nm, or less than about 30 nm. The particles can be agglomerated or non-agglomerated. Suitable pigments/pigment compositions include but are not limited to include azo (monoazo, disazo, β-naphthol, naphthol AS, salt type (lakes), benzimidazolone, condensation, metal complex, isoindolinone, isoindoline) and polycyclic (phthalocyanine, quinacridone, perylene, perinone, diketopyrrolo pyrrole, thioindigo, anthraquinone (indanthrone, anthrapyrimidine, flavanthrone, pyranthrone, anthanthrone, dioxazine, triarylcarbonium, quinophthalone) pigments, and mixtures thereof. It will be appreciated that a pigment is typically crystalline and insoluble, whereas a dye is a molecule that is typically soluble in a given solvent.

In certain nonlimiting embodiments, at least two colorants are used; the colorants can have, for example, a maximum absorbance peak in the range of about 400 to about 500 nm, a maximum absorbance peak in the range of about 500 to about 600 nm, and/or a maximum absorbance peak in the range of about 600 to about 700 nm. Any number and combination of colorant(s) and/or maximum absorbance peaks can be used.

In certain nonlimiting embodiments, at least some of the colorant(s) have a maximum haze of about 10%, such as a maximum haze of about 1%; in certain nonlimiting embodiments, substantially all of the colorant particles have one of these maximum haze values. Haze is a measurement of the transparency of a material and is defined by ASTM D1003. Lower haze values may impart greater transparency to the cast material.

In certain nonlimiting embodiments, the colorant(s) used according to the present invention exhibit a relatively narrow band of peak absorbance in the visible spectrum wherein at least about 50%, such as at least about 60%, of the total absorbance in the visible spectrum occurs at wavelengths within about 50 nm of the wavelength of peak absorbance. When more than one colorant is used, for example, one colorant can have at least about 70% (such as at least about 80%) of its total absorbance in the visible spectrum in the range of about 400 to about 500 nm, another colorant can have at least about 70% (such as at least about 75%) of its total absorbance in the visible spectrum in the range of about 500 to about 600 nm and/or another colorant can have at least about 60% (such as at least about 70%) of its total absorbance in the visible spectrum in the range of about 600 to about 700 nm. The combined features of low haze and narrow maximum absorbance peak in the visible spectrum of the colorant(s) can create a defined color effect. In certain embodiments, a relatively small number of different colorants (2 to 12) may be used in combination to produce a desired color.

In certain nonlimiting embodiments, the colorant(s) may be dispersed in at least one resinous binder. Suitable resinous binders include, for example, curable coating compositions having components such as hydroxyl or carboxylic acid-containing acrylic copolymers, hydroxyl or carboxylic acid-containing polyester polymers, oligomers and isocyanate or hydroxyl-containing polyurethane polymers, amine or isocyanate-containing polyureas, and any other suitable binder system. Suitable curing agents, if necessary, for the curable coating composition can be selected by one skilled in the art, and may include, for example, aminoplast resins and phenoplast resins and mixtures thereof, polyisocyanates and blocked polyisocyanates, anhydrides, polyepoxides, polyacids, polyols, and polyamines. The resinous binder should be selected so as not to interfere with the transparency and/or translucency of the cast material.

The castable materials of the present invention can be prepared by using methods standard in the art. The color effect composition can be within the cast material, and/or applied onto the cast material in, for example, coating or film form. For example, the color effect composition can be added to the castable materials and dispersed therein prior to cure. In addition to, or instead of, having the color effect composition within the cast material, the color effect composition can be applied to the outside of the cast material. For example, the color effect composition can be applied to the cast material in the form of a film, such as described above, or a coating, and be allowed to cure in an appropriate manner. The coating can be applied in any manner known in the art and cured as appropriate.

The present cast materials can further comprise a tactile effect composition. As with the color effect composition, the tactile effect composition can be within the cast material and/or can be applied to the surface of the cast material. If the tactile effect composition is within the cast material, enough of the tactile effect composition should be at the surface of the material for the tactile effect to be realized.

In certain embodiments of the present invention, the tactile effect composition and the color effect composition are applied together in one coating. For example, the color effect composition can be flaked or particularized and added to a coating having a tactile effect composition.

In certain other embodiments of the present invention, the color effect composition is in one coating layer, and the tactile effect composition is in another coating layer. For example, the coating that includes the color effect composition can be a basecoat, over which is applied a clearcoat that does not contain the color effect composition; in other embodiments, the clearcoat can comprise the tactile effect composition. A soft feel clearcoat is commercially available from PPG Industries, Inc., as VELVECRON. In this embodiment, the dry film thickness of the coating comprising the color effect composition can range from 1 to 50 microns, such as 3 to 15 microns, and the dry film thickness of the coating comprising the tactile effect composition can range from 0.1 to 20 mils, such as 1.5 to 4 mils.

The color effect composition can further comprise a number of standard additives that are enabling and/or suitable for using the color effect composition as a coating deposited on the surface of the cast material, and/or enabling and/or suitable for using the color effect composition within the cast material. For example, volatile materials can be included as diluents in the color effect compositions, including water and/or organic solvents, such as alcohols, ethers and ether alcohols, ketones, esters, aliphatic and alicyclic hydrocarbons, and aromatic hydrocarbons as are commonly employed in the coating industry. Examples of suitable solvents may include aliphatic solvents, such as hexane, naphtha, and mineral spirits; aromatic and/or alkylated aromatic solvents, such as toluene, xylene, and SOLVESSO 100 (aromatic blend from Exxon Chemicals); alcohols, such as ethyl, methyl, n-propyl, isopropyl, n-butyl, isobutyl and amyl alcohol, and m-pryol; esters, such as ethyl acetate, n-butyl acetate, isobutyl acetate and isobutyl isobutyrate; ketones, such as acetone, methyl ethyl ketone, methyl isobutyl ketone, diisobutyl ketone, methyl n-amyl ketone, and isophorone, glycol ethers and glycol ether esters, such as ethylene glycol monobutyl ether, diethylene glycol monobutyl ether, ethylene glycol monohexyl ether, propylene glycol monomethyl ether, propylene glycol monopropyl ether, ethylene glycol monobutyl ether acetate, propylene glycol monomethyl ether acetate, and dipropylene glycol monomethyl ether acetate.

The color effect compositions can further include one or more additives, such as UV absorbers and stabilizers, rheology control agents, surfactants, catalysts, film build additives, fillers, flatting agents, defoamers, microgels, pH control additives, and other pigments. Along with the color effect compositions, it may be useful in some cases to also include conventional pigments and dyes. These include micas, iron oxides, carbon black, titanium dioxide, aluminum flakes, bronze flakes, coated mica, nickel flakes, tin flakes, silver flakes, copper flakes, and combinations thereof. Other organic coloring agents (e.g., dyes or organic pigments) could also be included.

The color effect compositions of the present invention can be applied to the surface of the cast material using any suitable means, such as die coating, direct roll coating or reverse roll coating, curtain coating, spray coating, brush coating, gravure coating, flow coating, slot-dye coating, ink-jet coating, electrodeposition, and any combinations thereof. Powder coatings are generally applied by electrostatic deposition. One skilled in the art can select proper application methods if more than one layer is used, and will further know how to affect cure of the coating layer(s).

In certain nonlimiting embodiments, a curing agent can be used. Suitable curing agents for use in this invention include, but are not limited to, (a) unsaturated diols, (b) saturated diols, (c) unsaturated triols, (d) saturated triols, (e) unsaturated tetraols, (f) saturated tetraols, (g) polyols, (h) unsaturated diamines, (i) saturated diamine, (j) triamines, (k) tetramines, (l) polyamines, (m) amine- and hydroxy-containing hybrid curing agents, and a combination thereof. Appropriate curing agent(s) can be selected by one skilled in the art. 1,4-butane diol and trimethylol propane can be used, for example. CLEARLINK 1000 is a commercially available curing agent suitable for use in some embodiments of the present invention.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to prepolymers, oligomers and both homopolymers and copolymers; the prefix “poly” refers to two or more.

### EXAMPLES

The following examples are intended to illustrate the invention, and should not be construed as limiting the invention in any way.

### Example 1

### Ultraviolet Radiation Curable Organic Composition

An ultraviolet radiation curable organic composition was prepared via the following procedure. Diphenyl (2,4,6-trimethylbenzoyl) phosphine oxide/2-hydroxy-2-methylpropiophenone (30 grams), 50/50 blend from Aldrich Chemical Company, Inc., Milwaukee, Wis., in 818 g of ethyl alcohol, 140 grams of SR295 from Sartomer Company, Inc., Exton, Pa., and 130 grams of SR494 from Sartomer Company, Inc., Exton, Pa., were added with stirring to 730 grams SR9020 from Sartomer Company, Inc., Exton, Pa.

### Example 2

### Dispersion of Polymer Particles in Water

A dispersion of polymer particles in water was prepared via the following procedure: 2.45 grams of sodium bicarbonate from Aldrich Chemical Company, Inc., was mixed with 2045 grams of deionized water and added to a 1 gallon reaction kettle equipped with a thermocouple, baffles, stirrer, reflux condenser, heating mantle, and nitrogen inlet. The mixture was sparged with nitrogen for 40 minutes with stirring and blanketed with nitrogen. Aerosol MA80-I (23.23 grams) from Cytec Industries, Inc., West Paterson, N.J., in 229 grams deionized water was added to the mixture with stirring, and the mixture was heated to 50° C. using an electric mantle. Styrene monomer (416.4 grams) from Aldrich Chemical Company, Inc., was added with stirring. The mixture was heated to 60° C. Sodium persulfate from Aldrich Chemical Company, Inc., (6.2 g in 72 grams of deionized water) was added to the mixture with stirring. Divinyl benzene (102.7 grams), from Aldrich Chemical Company, Inc., was added to the mixture with stirring. Sodium persulfate was added with stirring 4.6 g in 43 grams of water. Styrene monomer (100.0 grams), methyl methacrylate monomer (239.4 grams), ethylene glycol dimethacrylate monomer (24.0 grams) and divinyl benzene monomer (15.1 grams) from Aldrich Chemical Company, Inc., were added with stirring. 3-Allyloxy-2-hydroxy-1-propanesulfonic acid, sodium salt (41.4 grams, 40% in water) from Aldrich Chemical Company, Inc. was added to the mixture with stirring. The temperature of the mixture was maintained at approximately 60° C. for 6 hours. The resultant polymer dispersion was allowed to cool to room temperature and was filtered through a 325 mesh stainless steel screen. The process was repeated. The two resultant dispersions were added together and ultrafiltered using an EP2524-BS01-T2 column from PTI Advance Filtration, Oxnard, Calif. Deionized water (approximately 600 grams) was added to the dispersion after approximately 600 grams of ultrafiltrate had been removed. This exchange was repeated 15 times. Additional ultrafiltrate was then removed until the solids content of the mixture was 41.2% by weight.

### Example 3

A cast urethane containing 1.0% by weight of pigment on resin solids of flake from Example 2 having color shifting effect was prepared as follows. Two resins were used to prepare the color shifting cast urethane, DESMODUR N-3300A, (commercially available from Bayer Chemical) and a 100% solids hydroxy functional acrylic resin. Specifically, the 100% solids hydroxy functional acrylic resin materials was heated to ˜150° F. The DESMODUR N-3300 was used at room temperature. Both resin materials were then degassed 5 minutes prior to use. Degassing was conducted using a degassing chamber (manufactured by Savoir Manufacturing Co., LLC) and avacuum pump (BOD Edwards, Model E2M18) at a vacuum of 28 mmHg for 5 minutes. 14.1 grams of the degassed DESMODUR N-3300A was poured into a mixing cup, (Parkway Plastics Inc., Piscataway, N.J.), for use on a Flat-Tek high speed mixer. 35.9 grams of the degassed hydroxy functional acrylic was poured onto the DESMODUR N-3300A. 0.5 grams of the flake prepared according to Example 2, which had the consistency of a flaked powder, were added to the resin blend. The blend of materials was then placed into the Flat-Tek high speed mixer for 5 minutes at a 2500 rpm spin rating. When the Flat-Tek high speed mixer finished the 5 minute mixing cycle, the materials were placed into an electric oven set at 250° F. for an overnight cure (approximately 18 hours @ 250° F.). When the material was removed from the mixing cup, the cast material in the shape of a “hockey puck” (3¼″ wide by ⅜″ height) had color changing properties, where it would appear red when viewing the hockey-puck directly, but would lose color when observed at low angles.

### Example 4

### Color Effect Film

Eighteen hundred grams of material prepared in Example 2 was applied via slot-die coater from Frontier Technologies, Towanda, Pa. to a polyethylene terephthalate substrate and dried at 180° F. for 40 seconds to a porous dry film thickness of approximately 7.0 microns. One thousand grams of material prepared in Example 1 was applied via slot-die coater from Frontier Industrial Technologies into the interstitial spaces of the porous dry film on the polyethylene terephthalate substrate, dried at 150° F. for 40 seconds, and then ultraviolet radiation cured using a 100 W mercury lamp. The color effect film can then be applied to the surface of a cast material, such as one prepared according to Example 3 (but without the flake of Example 2), and the polyethylene terephthalate substrate peeled off. The color changing properties reported in Example 3 would be expected.

### Example 5

### Tactile Color Effect

The color effect film of Example 4 can be further coated with 50 to 75 microns (dry film thickness) of VELVECRON XPC30002, from PPG Industries, Inc., Pittsburgh, Pa., via spray application, such as after application of the color effect film to the cast material. The painted cast material can be dried at room temperature for 10 minutes then cured using a convection oven for 30 minutes at a temperature of 180° F. The perceived color of the cast material is expected to change with viewing angle and to have a soft velvet-like feel.

### Example 6

### Color Effect Flake

Eighteen hundred grams of material prepared in Example 2 was applied via slot-die coater from Frontier Technologies, Towanda, Pa., to a polyethylene terephthalate substrate and dried at 180° F. for 40 seconds to a porous dry film thickness of approximately 4 microns. One thousand grams of material prepared in Example 1 was applied via slot-die coater from Frontier Industrial Technologies into the interstitial spaces of the porous dry film on the polyethylene terephthalate substrate, dried at 150° F. for 40 seconds, and then ultraviolet radiation cured using a 100 W mercury lamp. The cured film was removed from the polyethylene terephthalate substrate and milled to approximately 38-53 microns in size using a model ZM100 centrifugal mill from Retsch GmbH & Co. KG, Haan, Germany.

### Example 7

### Tactile Color Effect Coating

Twenty grams of material prepared in Example 6 can be added with stirring to 80 grams of VELVECRON XPC30002. The resulting composition can be applied to a cast material, such as via spray application, to a dry film thickness of 50 to 75 microns. The perceived color of the cast material is expected to change with viewing angle and to have a soft velvet-like feel.

### Example 8

A pigment dispersion was made by grinding 15 grams of red pigment (IRGAZIN Red 379, available from Ciba Specialty Corporation, Tarrytown, N.Y.) with 16.6 grams of SOLSPERSE 27000 (Lubrizol Corporation, Wickliffe, Ohio) and 246 grams of 1,4-butanediol (GAF Chemicals Corporation, Wayne, N.J.) in a 1-liter, stainless steel, water jacketed vessel, using a high speed disperser (Model 2000 Dispersator from Premier Mill, Reading, Pa.) at a speed of 6000 rpms for 10 hours. The mixture was milled with 600 grams of glass spheres (GL-0179 DURASPHERES from MO-Sci Corporation, Rolla, Mo.). After milling, the pigment dispersion was separated from the glass spheres by vacuum assisted filtration through a 1-micron bag filter. The final pigment dispersion was 9.1% total solids and 4.3% pigment. The pigment dispersion had a percent haze of 14.6% at a percent transmission of 17.5% at the wavelength of maximum absorbance.

### Example 9

A cast urethane containing 0.01% by weight of pigment on resin solids of the pigment prepared in Example 8 used for color tinting effect was prepared as described in Example 3 only using 14.380 grams of the degassed. DESMODUR N-3300A, 35.526 grams of the degassed hydroxy functional acrylic and, instead of the flake of Example 2, 0.104 grams of the pigment solution prepared according to Example 8, which has the consistency of a liquid. When the material was removed from the mixing cup, the cast material in the shape of a “hockey-puck” (3¼ wide by ⅜″ height) had a clear red tint appearance. It is significant that such a color effect was observed with such a low pigment to binder ratio.

### Example 10

CHROMOTHAL Yellow BGN (Ciba Specialty Chemicals, Inc., High Point, N.J.) was milled and dispersed on an ADVANTIS mill (Draiswerke, Inc., Mahwah, N.J.) using SOLSPERSE dispersants (Avecia, Inc., Wilmington, Del.) and ZONYL (polytetrafluoroethylene) (E.I. duPont de Nemours and Company, Wilmington, Del.), Table 1 sets forth the milling components and conditions. For analysis, the final colorant was diluted with n-butyl acetate. Table 2 lists the properties of the final colorant. The average primary particle size was obtained with a Philips CM12 transmission electron microscope (TEM) at 100 kV. The percent haze was measured with a Byk-Gardner TCS (The Color Sphere) instrument having a 500 micron cell path length. With this colorant, 85% of the total absorbance in the visible spectrum occurs between the wavelengths of 400 to 500 nm.

TABLE 1

| | Example | | | | | | |
|---|---|---|---|---|---|---|---|
| % of mill base | 1 | 2 | 3 | 4 | 5 | 6 | 7 |
| Pigment | 8.17 | 13.56 | 13.24 | 9.34 | 5.00 | 9.20 | 4.80 |
| SOLSPERSE 5000 | 0 | 0 | 2.07 | 0.89 | 0 | 0 | 0 |
| SOLSPERSE 22000 | 0 | 0 | 0 | 0 | 0 | 0.18 | 0.94 |
| ZONYL FSO | 0.12 | 0 | 0 | 0 | 0 | 0.00 | 0.00 |
| SOLSPERSE 32500 | 0 | 33.88 | 29.94 | 41.12 | 2.59 | 0 | 0 |
| SOLSPERSE 31845 | 0 | 0 | 0 | 0 | 0 | 26.18 | 0 |
| Dispersant* | 10.73 | 0 | 0 | 0 | 0 | 0 | 13.83 |
| Acrylic grind polymer** | 30.20 | 0 | 0 | 0 | 33.94 | 17.92 | 49.06 |
| n-butyl acetate | 37.60 | 35.04 | 48.86 | 36.60 | 38.98 | 31.18 | 22.68 |
| Dowanol PM acetate | 13.23 | 17.52 | 5.89 | 12.05 | 19.49 | 15.34 | 8.70 |
| Mill residence time (min.) | 185 | 37 | 55 | 103 | 63 | 443 | 319 |
| Media size (mm) | 0.3 | 0.3 | 0.3 | 0.2 | 0.2 | 0.3 | 0.2 |
| *A quaternary ammonium group containing polymer prepared as generally described in U.S. Pat. No. 6,365,666 B1, by atom transfer radical polymerization techniques from the following monomers on a weight basis: 4.7% glycidyl methacrylate, 20.3% benzylmethacrylate, 14.1% butylmethacrylate, 52.3% 2-ethyhexylmethacrylate | | | | | | | |
| # and 7.1% of hydroxypropyl methacrylate. The polymer was quaternized with the lactic acid salt of dimethethanol amine. The polymer has an M(n) of 9505 and an M(w) of 15,445 as determined by gel permeation chromatography using a polystyrene standard. | | | | | | | |

**An acrylic polymer iminated with propylene imine prepared by solution polymerization techniques from the following monomers on a weight basis: 29.32% styrene, 19.55% 2-ethylhexyl acrylate, 19.04% butyl methacrylate, 9.77% 2-hydroxyethyl acrylate, 1.86% methacrylic acid, and 0.59% acrylic acid.

TABLE 2

| | Example | | | | | | |
|---|---|---|---|---|---|---|---|
| Properties | 1 | 2 | 3 | 4 | 5 | 6 | 7 |
| TEM primary | 100 | 20 | 30 | 20 | 60 | 90 | 50 |
| particle | | | | | | | |
| size (nm) | | | | | | | |
| % Haze* | 9.18 | 0.17 | 0.13 | 0.33 | 0.71 | 3.03 | 2.25 |
| % IA** | 75 | 70 | 67 | 67 | 59 | 66 | 75 |
| % Total solids | 31.42 | 30.32 | 38.43 | 24.9 | 41.28 | 32.12 | 37.18 |
| (by weight)*** | | | | | | | |
| % Pigment | 8.92 | 7.98 | 9.73 | 8.75 | 4.97 | 8.48 | 5.55 |
| (by weight)*** | | | | | | | |

*Percent haze at a transmittance of about 17.5% at the wavelength of maximum absorbance
**Percent of integrated absorbance within the visible range that lies within a 100 nm wavelength range centered at the wavelength of maximum absorbance.
***The colorants were adjusted to attain these final % solids and % pigment values.

These pigment dispersions could be incorporated into one or more resinous binders and applied to and cured on the surface of a cast material using any suitable means.

Whereas particular embodiments of this invention have been described above for purposes of illustration, it will be evident to those skilled in the art that numerous variations of the details of the present invention may be made without departing from the invention as defined in the appended claims.

What is claimed is:

1. A translucent and/or transparent cast material having at least one color effect composition that imparts a desired color and/or visual effect that is not generated solely through the use of a dye.

2. The cast material of claim 1, wherein the color effect composition comprises nanosized colorant particles.

3. The cast material of claim 2, wherein the color effect composition comprises more than one type of colorant particles.

4. The cast material of claim 3, wherein one or more of the colorant particles has a maximum absorbance peak of 400 to 500 nanometers, 500 to 600 nanometers, or 600 to 700 nanometers.

5. The cast material of claim 4, wherein the majority of the colorant particles have a maximum haze of 10%.

6. The cast material of claim 1, wherein the color effect composition comprises an ordered periodic array of particles held in a matrix.

7. The cast material of claim 6, wherein the matrix is a polymer matrix.

8. The cast material of claim 7, wherein the polymer is a crosslinked polymer.

9. The cast material of claim 1, wherein the cast material comprises polyurethane, a copolymer of polyurethane, a polyurea, and/or a copolymer of polyurea.

10. The cast material of claim 9, wherein the cast material is translucent.

11. The cast material of claim 9, wherein the cast material is transparent.

12. The cast material of claim 1, wherein the color effect composition is within the cast material.

13. The cast material of claim 1, wherein the color effect composition is coated on the surface of the cast material.

14. The cast material of claim 1, wherein the cast material further comprises a tactile effect composition.

15. The cast material of claim 2, wherein the colorant particles have a primary particle size of 150 nanometers, or less.

16. The cast material of claim 2, wherein the colorant particles have a primary particle size of 70 nanometers, or less.

17. The cast material of claim 2, wherein the colorant particles have a primary particle size of 30 nanometers, or less.

18. The cast material of claim 5, wherein the majority of the colorant particles have a maximum haze of 1%.
